(19) United States
(12) Patent Application Publication
(10) Pub. No.: US 2024/0359253 A1
(43) Pub. Date: Oct. 31, 2024

(54) ONE-SIDED SPOT WELDER AND ONE-SIDED SPOT-WELDING METHOD

(71) Applicant: Obara Corporation, Yamanashi (JP)

(72) Inventors: Keiichirou KIMOTO, Osaka (JP); Masafumi KISHIMOTO, Osaka (JP); Nobuhiro FURUSE, Osaka (JP); Takashi TERADA, Yamanashi (JP); Toshirou JOU, Yamanashi (JP)

(21) Appl. No.: 18/641,718

(22) Filed: Apr. 22, 2024

(30) Foreign Application Priority Data
Apr. 27, 2023 (JP) 2023-073473

(51) Int. Cl. B23K 11/11; B23K 101/00

(52) U.S. Cl. CPC B23K 11/115; B23K 2101/006

(57) ABSTRACT

A one-sided spot welder includes a cylinder that includes a cylinder body and a rod, the rod projecting from an inside of the cylinder body by driving the rod toward one side in an axial direction, the rod retracting toward the inside of the cylinder body by driving the rod toward another side in the axial direction; an arm that is fixed to the rod; and a first welding electrode that is fixed to the arm, a tip of the first welding electrode being disposed on the another side in the axial direction than a base end of the first welding electrode.

### CROSS-REFERENCE TO RELATED APPLICATION

This application is based upon and claims the benefit of priority from Japanese Patent Application No. 2023-073473 filed to the Japan Patent Office on Apr. 27, 2023, the entire disclosure of which is incorporated herein by reference.

### FIELD OF THE INVENTION

The present disclosure relates to a one-sided spot welder and a one-sided spot welding method.

### BACKGROUND

For example, in an automobile body welding step, it is often used a so-called direct spot welding in which electricity is applied in a condition that an overlapped portion of steel plates is clamped by a pair of electrodes with pressure. However, for areas that cannot be clamped by a pair of electrodes, one-sided spot welding (indirect spot welding, series spot welding, etc.) may be used, in which a welding electrode is brought into abutment from only one side in its thickness direction.

FIG. 8 shows a welding gun 100 of an indirect spot welder shown in International Publication No. 2015/033537. This welding gun 100 includes a welding electrode 134, a drive unit 130 that drives the welding electrode, and a bracket 135 that is attached to a tip of a robotic arm (articulated robot) not shown in the drawings. The drive unit 130 includes a servomotor 131, a casing 132, and a rod 133. The servomotor 131 is driven to make the rod 133 project from the casing 132 such that the welding electrode 134 is pressed against a target joining area of a work. Under this condition, electricity is applied between the welding electrode 134 and an earth electrode (omitted in the drawings) that is in contact with a place away from the target joining area of the work, thereby forming a nugget at the target joining area.

In the above-mentioned general indirect spot welder, the welding electrode 134 is pressed against the work by pushing the rod 133 of the drive unit 130 out of the casing 132. For example, as shown in FIG. 9, in the case of welding from the inside of a vehicle body 200 by using such welder, it is necessary to conduct an operation in which the welding gun 100 including the drive unit 130 is allowed to enter the vehicle body 200 through a door opening 201 of the vehicle body 200, then the welding gun 100 is inverted inside the vehicle body 200, and then a tip of the welding electrode 134 is opposed to a target joining area 202 from the interior side. Since such operation is very complicated, cycle time is extended.

On the other hand, as shown in FIG. 10, if the welding gun 100 is allowed to enter the vehicle body from the opposite door opening (not shown in the drawings), it is possible to press the tip of the welding electrode 134 against the target joining area 202 from the interior side, without inverting the welding gun 100 inside the vehicle body 200. However, if the welding gun 100 is allowed to enter the vehicle body deep to reach around the door opening 201, the other welding robots must wait (interlock) for a longer time during which their entry into the inside of the vehicle body 200 is limited to prevent interference with the welding gun 100 in operation in the interior, thereby extending cycle time of the welding step.

### SUMMARY

The present disclosure provides a one-sided spot welder that can easily weld a target joining area of a plurality of metal plates from the back side (for example, the vehicle interior side), too.

The present disclosure provides a one-sided spot welder that includes a cylinder having a cylinder body and a rod, the rod projecting from an inside of the cylinder body by driving the rod toward one side in an axial direction, the rod retracting toward the inside of the cylinder body by driving the rod toward another side in the axial direction; an arm that is fixed to the rod; and a first welding electrode that is fixed to the arm, a tip of the first welding electrode being disposed on the another side in the axial direction than a base end of the first welding electrode.

In the present disclosure, as mentioned above, the welding electrode is attached to the rod through the arm, and the tip of the welding electrode is disposed on the another side (rod retraction side) in the axial direction than the base end. In this case, it is possible to press the first welding electrode against the target joining area of the plurality of metal plates from the one side (side opposite to the cylinder) in the axial direction by disposing the target joining area of the plurality of metal plates on the another side in the axial direction of the first welding electrode and then driving the rod of the cylinder toward the another side in the axial direction, that is, retracting the rod toward the inside of the cylinder body.

The one-sided spot welder may further include a second welding electrode that is fixed to the arm, a tip of the second welding electrode being disposed on the one side in the axial direction than a base end of the second welding electrode. In this case, it is possible to press the second welding electrode against the target joining area of the plurality of metal plates from the another side (cylinder side) in the axial direction by disposing the target joining area of the plurality of metal plates on the one side in the axial direction of the second welding electrode and then driving the rod of the cylinder toward the one side in the axial direction, that is, making the rod project from the inside of the cylinder body. In this manner, it becomes possible to weld various spots with a single welder by including the first welding electrode that presses the target joining area by retracting the rod of the cylinder and the second welding electrode that presses the target joining area by making the rod of the cylinder project. With this, it is possible to reduce the number of welders to lower the cost and possible to decrease the space for installing welders.

In the above one-sided spot welder, the rod of the cylinder and the first welding electrode are connected together via the arm. Therefore, when the first welding electrode presses at its tip the target joining area of the plurality of metal plates, a large moment may be added to a base of the arm (joint between the arm and the rod of the cylinder). If the rod is inclined by this moment, a smooth reciprocation of the rod may become difficult to lower the response of the cylinder.

Thus, the one-sided spot welder may further include a floating joint at which the rod and the arm are joined. This floating joint is configured to transmit an axial force of the rod to the arm while allowing an inclination of the rod and the arm relative to each other. With this, even if the arm receives a moment load by the reaction force in response to the pressing force of the welding electrode, the floating joint can absorb this moment load, thereby preventing the moment load from being added to the rod as a drive means. With this, it is possible to prevent the inclination of the rod, thereby achieving a smooth reciprocation of the rod and improving the response of the cylinder.

According to the above one-sided spot welder, when the target joining area of the plurality of metal plates that constitute a vehicle body is joined, a welding can be conducted in a condition that the cylinder is disposed outside the vehicle body and that the first welding electrode is disposed inside the vehicle body. With this, handling of the welding gun becomes easier as compared with the case in which the whole welding gun including the cylinder is disposed inside the vehicle body.

### BRIEF DESCRIPTION OF DRAWINGS

FIG. 1 is a plan view of a vehicle body welding facility.

FIG. 2 is a side view of an indirect spot welder according to one embodiment of the present disclosure.

FIG. 3 is a side view of a welding gun.

FIG. 4 is a sectional view of a cylinder.

FIG. 5 is a sectional view of a floating joint.

FIG. 6 is a sectional view showing a condition of welding using a first welding electrode.

FIG. 7 is a sectional view showing a condition of welding using a second welding electrode.

FIG. 8 is a side view of a welding gun of a conventional indirect spot welder.

FIG. 9 is a sectional view showing an example in which welding is conducted on a target joining area of a vehicle body with a conventional welding gun from the interior side.

FIG. 10 is a sectional view showing another example in which welding is conducted on the target welder area of the vehicle body with the conventional welding gun from the interior side.

### DETAILED DESCRIPTION

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

In the following, an embodiment of the present disclosure will be explained with reference to the drawings.

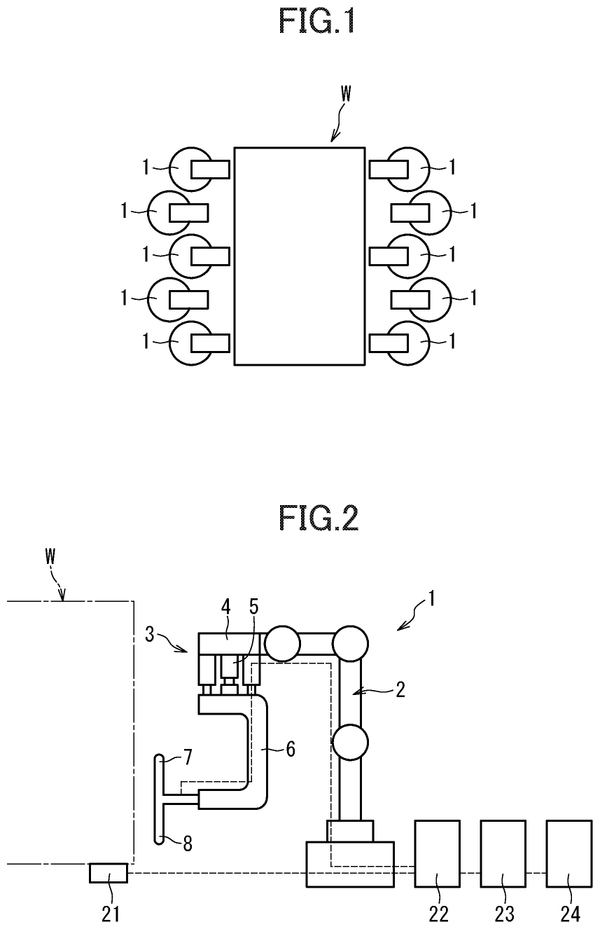

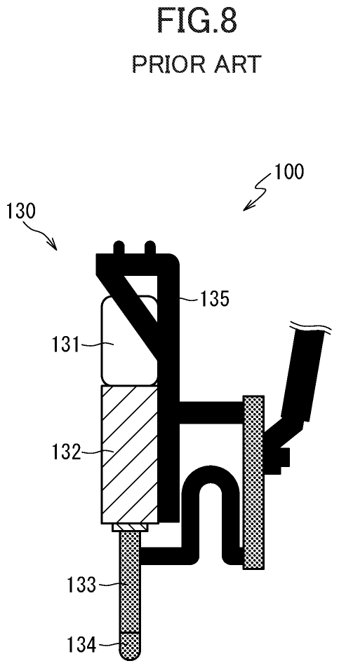

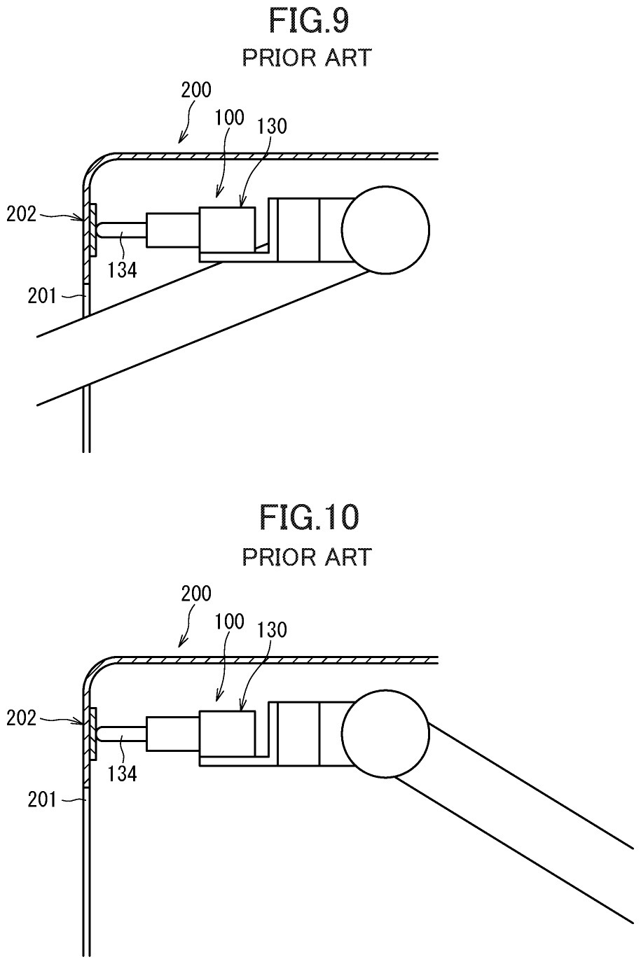

FIG. 1 is a plan view of a vehicle body welding facility. In this vehicle body welding facility, a plurality of welders (five in an example shown in the drawing) are disposed on each lateral side of a vehicle body W. As one of these welders, there is used an indirect spot welder 1 that is a one-sided spot welder according to one embodiment of the present disclosure. For a part of the welders provided in this vehicle body welding facility, a direct spot welder or a conventional indirect spot welder (see FIG. 8) may be used.

As shown in FIG. 2, the indirect spot welder 1 (hereinafter referred to as simply “welder 1”) includes an articulated robotic arm 2, a welding gun 3 that is attached to a tip of the robotic arm 2, and an earth electrode 21. The welding gun 3 includes a mount portion 4 that is attached to a tip of the robotic arm 2, a cylinder 5, an arm 6, and first and second welding electrodes 7, 8. The welding gun 3 is disposed in any posture at any three-dimensional position within a movable range of the robotic arm 2. The earth electrode 21 is fixed in a condition in contact with a predetermined position of the vehicle body W. The first and second welding electrodes 7, 8 and the earth electrode 21 are electrically connected to a transformer 22, a controller 23, and a power source 24.

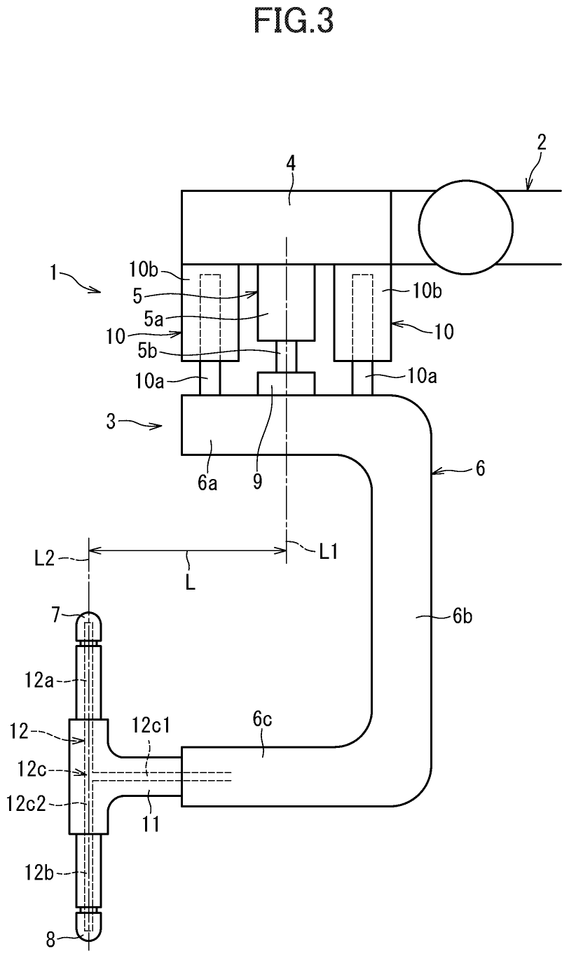

As shown enlarged in FIG. 3, the cylinder 5 includes a cylinder body 5a that is fixed to the mount portion 4, and a rod 5b that is provided to be able to advance and retract relative to the cylinder body 5a. The rod 5b is made reciprocatable in its axial direction. For the cylinder 5, it is possible to use an air cylinder, a hydraulic cylinder, an electric cylinder, etc. In the present embodiment, an air cylinder is used. Hereinafter, the rod 5b's movement direction (vertical direction in FIG. 3) is referred to as “axial direction”. In the explanations using FIG. 3, the side (lower side in FIG. 3) to which the rod 5b projects from the cylinder body 5a in the axial direction may also be referred to as the lower side, and the opposite side (upper side in FIG. 3) as the upper side, but this is not intended to limit the mode of using the welding gun 3.

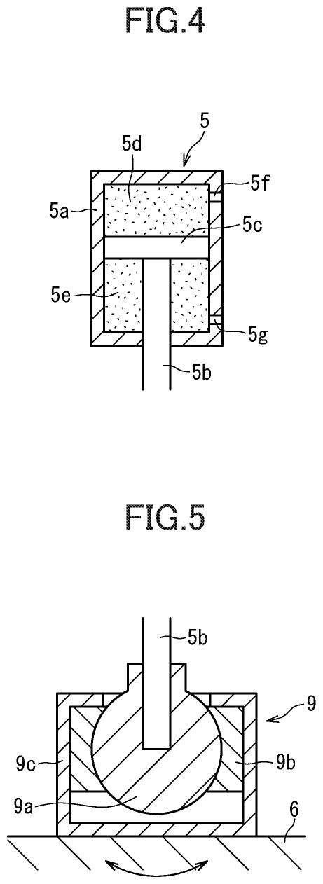

As shown in FIG. 4, the cylinder 5 according to the present embodiment includes a piston 5c inside the cylinder body 5a, and the rod 5b is fixed to this piston 5c. The piston 5c divides the inside of the cylinder body 5a into a first space 5d and a second space 5e. By supplying the fluid pressure (air pressure in the present embodiment) into the first space 5d from a first supply hole 5f, the piston 5c is moved downward, thereby moving the rod 5b to a side of projecting from the cylinder body 5a. On the other hand, when the fluid pressure is supplied to the second space 5e from the second supply hole 5g, the piston 5c is moved upward, thereby retracting the rod 5b toward the inside of the cylinder body 5a.

The rod 5b of the cylinder 5 is linked at its end portion to the arm 6 (see FIG. 3). According to an example shown in the drawings, the end portion of the rod 5b is linked to the arm 6 via a floating joint 9. The floating joint 9 is one that transmits an axial force of the rod 5b to the arm 6 while allowing an inclination of the rod 5b and the arm 6 relative to each other. As shown in FIG. 5, the floating joint 9 according to the present embodiment includes a spherical portion 9a that is fixed to a lower end of the rod 5b, a receiving portion 9b that is provided on an outer periphery of the spherical portion 9a, and a housing 9c to which the receiving portion 9b is fixed. An outer spherical surface of the spherical portion 9a is slidably supported on an inner spherical surface of the receiving portion 9b, thereby allowing an inclination of the receiving portion 9b relative to the spherical portion 9a (see arrows in FIG. 5). Furthermore, the spherical portion 9a and the receiving portion 9b are engaged with each other in the axial direction (vertical direction in the drawing). Therefore, the force to move the rod 5b in the axial direction is transmitted to the arm 6 via the receiving portion 9b and the housing 9c.

The welding gun 3 is provided with guide mechanisms 10 that guide the movement direction of the arm 6 (see FIG. 3). In an example shown in the drawings, two guide mechanisms 10 are provided on both sides interposing the cylinder 5. Each guide mechanism 10 includes a guide pin 10a that is fixed to the arm 6, and a guide member 10b that is fixed to the mount portion 4. While the guide pin 10a is supported by the guide member 10b, a relative axial movement of them is allowed, such that the arm is guided to move in an axial direction (vertical direction in the drawing). As the guide mechanism 10, it is possible to use a linear motion guide mechanism such as ball splines, etc.

The arm 6 is formed by a metal such as aluminum alloy and is generally C shaped in a side view shown in FIG. 3. Specifically, the arm 6 includes in one-piece a first portion 6a that extends in a direction perpendicular to the axial direction, a second portion 6b that extends downward from one end of the first portion 6a, and a third portion 6c that extends from a lower end of the second portion 6b in a direction generally parallel with the first portion 6a. Since the arm 6 is C shaped, it is possible to secure a space for disposing the work on an inner side of the arm 6.

To the third portion 6c of the arm 6, the first and second welding electrodes 7, 8 are fixed. In an example shown in the drawing, both welding electrodes 7, 8 are fixed to a lower end (the third portion 6c) of the arm 6 via an electrode fixing member 11. The first welding electrode 7 extends upwardly from the electrode fixing member 11, and its tip is disposed at an upper position than its base end fixed to the electrode fixing member 11. In other words, the first welding electrode 7 is disposed in a condition that its tip is directed upward. The second welding electrode 8 extends downwardly from the electrode fixing member 11, and its tip is disposed at a lower position than its base end fixed to the electrode fixing member 11. In other words, the second welding electrode 8 is disposed in a condition that its tip is directed downward. In an example shown in the drawing, axes of the first and second welding electrodes 7, 8 are parallel with the axial direction. In an example shown in the drawing, the first and second welding electrodes 7, 8 are coaxially disposed.

A cooling flow path 12 for circulating a cooling water is provided inside the first and second welding electrodes 7, 8 and the electrode fixing member 11. Specifically, the cooling flow path 12 includes a first flow path 12a that is provided inside the first welding electrode 7, a second flow path 12b that is provided inside the second welding electrode 8, and a third flow path 12c that is provided inside the electrode fixing member 11. The third flow path 12c includes a transverse flow path 12c1 that extends in a direction perpendicular to the axial direction, and a longitudinal flow path 12c2 that is branched at an end portion of the transverse flow path 12c1 and extends in the axial direction. In the present embodiment, the first and second welding electrodes 7, 8 are coaxially provided. Therefore, the first and second flow paths 12a, 12b and the longitudinal flow path 12c2 of the third flow path 12c can be formed by a single axial hole.

Both welding electrodes 7, 8 are coaxially disposed and are parallel with the axial direction. Therefore, a distance L between an axis L1 of the cylinder 5 and an axis of each welding electrode 7, 8 is even. With this, it becomes easy to calculate the pressure at which each welding electrode 7, 8 is pressed against the target joining area, from the pressure of the cylinder.

Next, a method for welding a target joining area of the vehicle body W from the interior side by the above welder 1 will be described.

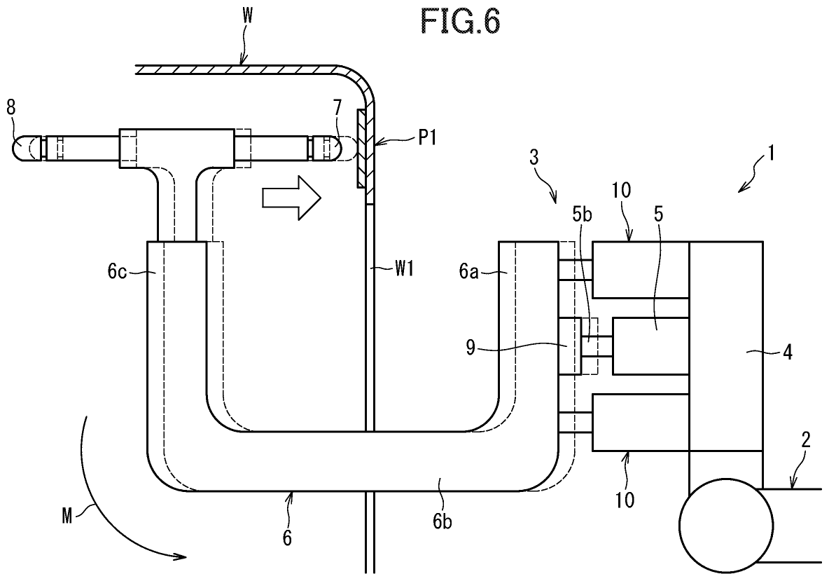

With reference to FIG. 6, the case of conducting a welding by using the first welding electrode 7 will be described. The one side of the first welding electrode 7 in the axial direction is the left side of the first welding electrode 7 in FIG. 6. Firstly, a part of the welding gun 3 is allowed to enter an opening W1 of the vehicle body W, such that the first welding electrode 7 is disposed inside the vehicle body W and that the cylinder 5 is disposed outside the vehicle body W. Then, a target joining area P1 of the vehicle body W is disposed on the another side (side of the cylinder 5 or right side in the drawing) in the axial direction of the first welding electrode 7, and the tip of the first welding electrode 7 is opposed to the target joining area P1 of the vehicle body W from the interior side.

Then, the rod 5b of the cylinder 5 is driven to retract such that the first welding electrode 7 is withdrawn toward the another side in the axial direction (see “void arrow” in FIG. 6). With this, the tip of the first welding electrode 7 is pressed against the target joining area P1 of the vehicle body W from the interior side (see dotted lines). The cylinder according to the present embodiment is an air cylinder. Therefore, if a predetermined air pressure is supplied to the second space 5e of the cylinder 5 (see FIG. 4), the pressure at which the first welding electrode 7 is pressed against the target joining area P1 is maintained constant, without necessity of a complicated control. Under this condition, the electric current supplied from the power source 24 shown in FIG. 2 is amplified by the transformer 22 based on the command from the controller 23, followed by supplying to the first welding electrode 7, such that electricity is allowed to flow through a passage of the first welding electrode 7, the vehicle body (target joining area P1), and the earth electrode 21. With this, a nugget is formed at the target joining area P1 to join the metal plates.

In this way, it is possible to easily weld the target joining area P1 from the interior side by pressing the first welding electrode 7 against the target joining area P1 from the interior side by the withdrawal operation of the cylinder 5, under a condition that the cylinder 5 is disposed outside the vehicle body W, without putting the whole welding gun 3 into the inside of the vehicle body W.

While the welder 1 conducts the welding operation on the target joining area P1, other welders are prevented from entering an operation area of the welder 1 (interlock function). In the present embodiment, as shown in FIG. 6, only a part of the welding gun 3 is disposed inside the vehicle body W, and the cylinder 5, the first portion 6a of the arm 6, etc. are disposed outside the vehicle body W. Therefore, even while the welder 1 welds the target joining area P1, the welding guns of other welders are allowed to enter the interior of the vehicle body. This shortens the waiting time (interlock) of other welders, thereby reducing the cycle time of the welding step.

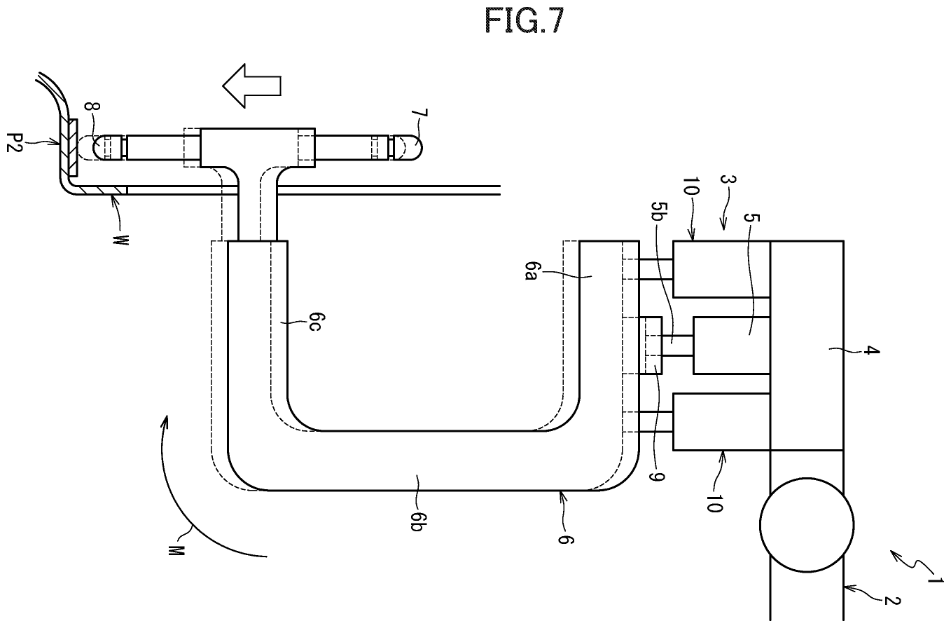

Next, with reference to FIG. 7, the case of conducting welding by using the second welding electrode 8 will be described. Firstly, a target joining area P2 of the vehicle body W is disposed on the one side (a side opposite to the cylinder, a lower side in the drawing) in the axial direction of the second welding electrode 8, and a tip of the second welding electrode 8 is opposed to the target joining area P2 of the vehicle body W. Then, the rod 5b of the cylinder 5 is driven to project, such that the second welding electrode 8 is allowed to project toward the one side in the axial direction (see “void arrow” in FIG. 7). With this, the tip of the second welding electrode 8 is pressed against the target joining area P2 of the vehicle body W (see dotted lines). Under this condition, the electric current supplied from the power source 24 shown in FIG. 2 is amplified by the transformer 22 based on the command from the controller 23, followed by supplying to the second welding electrode 8, such that electricity is allowed to flow through a passage of the second welding electrode 8, the vehicle body (target joining area P2), and the earth electrode 21. With this, a nugget is formed at the target joining area P2 to join the metal plates.

As above, the welder 1 includes the first welding electrode 7 of which tip is directed to the another side (upper side in FIG. 3) in the axial direction, and the second welding electrode 8 of which tip is directed to the one side (lower side in FIG. 3) in the axial direction. Thus, the welder 1 as a single welder can weld various spots. With this, it is possible to reduce the number of the welders 1 surrounding the vehicle body W in the welding step (see FIG. 1), thereby lowering the cost and saving the space.

By the way, when the welding electrode 7, 8 is pressed against the target joining area P1, P2, the reaction force adds the moment M to the arm 6 (see FIGS. 6 and 7). In the present embodiment, the guide mechanisms 10 are provided to guide the arm 6 in the axial direction. Therefore, it is possible to suppress the inclination of the arm 6 caused by the moment M. In particular, in an example shown in the drawings, the two guide mechanisms 10 are separately provided on both sides of the cylinder 5 in a direction perpendicular to the axial direction. This improves rigidity of the arm 6 against the moment M.

However, it may be difficult to perfectly suppress the inclination of the arm 6 even by the guide mechanisms 10. Therefore, the arm 6 may be slightly inclined by the reaction force caused by the pressing force of the welding electrode 7, 8. Upon this, the floating joint 9 allows the inclination of the arm 6 relative to the rod 5b of the cylinder 5. Therefore, it is possible to prevent the moment M added to the arm 6 from being transmitted to the rod 5b of the cylinder 5. With this, the rod 5b of the cylinder 5 is always reciprocated in a condition parallel with the axial direction, thereby achieving a smooth operation of the rod 5b and the piston 5c and improving the response of the cylinder 5.

In the following, other embodiments of the present disclosure will be described, but the repetitive description of points similar to those of the above embodiment will be omitted for simplification.

For example, the welder 1 may be configured to include only the first welding electrode 7 by omitting the second welding electrode 8.

The first and second welding electrode 7, 8 may be non-coaxially provided at different positions in a direction perpendicular to the axial direction. Furthermore, one or both of the first and second welding electrodes 7, 8 may be plurally provided.

The first welding electrode 7 may extend in a direction that is inclined relative to the axial direction. In this case, the tip of the first welding electrode 7 is disposed on the another side (side of the cylinder 5) in the axial direction than its base end. Similarly, the second welding electrode 8 may extend in a direction that is inclined relative to the axial direction. In this case, the tip of the second welding electrode 8 is disposed on the one side (side opposite to the cylinder 5) in the axial direction than its base end.

The arm 6 may have another shape such as L-shape in side view.

The present disclosure is not limited to an indirect spot welder, but may be applied to a one-sided spot welder in which a welding electrode is brought into abutment with a target joining area of a plurality of metal plates from only one side in the thickness direction. For example, the present disclosure can be applied to a series spot welder in which a pair of the first welding electrodes is brought into abutment with a plurality of metal plates from only one side in the thickness direction.

What is claimed is:

1. A one-sided spot welder comprising:
a cylinder that comprises a cylinder body and a rod, the rod projecting from an inside of the cylinder body by driving the rod toward one side in an axial direction, the rod retracting toward the inside of the cylinder body by driving the rod toward another side in the axial direction;
an arm that is fixed to the rod; and
a first welding electrode that is fixed to the arm, a tip of the first welding electrode being disposed on the another side in the axial direction than a base end of the first welding electrode.

2. The one-sided spot welder according to claim 1, further comprising a second welding electrode that is fixed to the arm, a tip of the second welding electrode being disposed on the one side in the axial direction than a base end of the second welding electrode.

3. The one-sided spot welder according to claim 1, further comprising a floating joint at which the rod and the arm are joined, the floating joint being configured to transmit an axial force of the rod to the arm while allowing an inclination of the rod and the arm relative to each other.

4. A method for joining a target joining area of a plurality of metal plates by using a one-sided spot welder comprising:
a cylinder that comprises a cylinder body and a rod, the rod projecting from an inside of the cylinder body by driving the rod toward one side in an axial direction, the rod retracting toward the inside of the cylinder body by driving the rod toward another side in the axial direction;
an arm that is fixed to the rod; and
a first welding electrode that is fixed to the arm,
the method comprising the steps of:
disposing the target joining area of the plurality of metal plates on the another side in the axial direction of the first welding electrode; and
pressing the first welding electrode against the target joining area of the plurality of metal plates from the one side in the axial direction by driving the rod of the cylinder toward the another side in the axial direction.

5. The method according to claim 4, wherein, when the target joining area of the plurality of metal plates that constitute a vehicle body is joined, a welding is conducted in a condition that the cylinder is disposed outside the vehicle body and that the first welding electrode is disposed inside the vehicle body.

6. The one-sided spot welder according to claim 2, further comprising a floating joint at which the rod and the arm are joined, the floating joint being configured to transmit an axial force of the rod to the arm while allowing an inclination of the rod and the arm relative to each other.
